(19) United States
(12) Patent Application Publication
(10) Pub. No.: US 2025/0353184 A1
(43) Pub. Date: Nov. 20, 2025

(54) INFORMATION PROCESSING DEVICE, INFORMATION PROCESSING METHOD, AND PROGRAM

(71) Applicant: SONY SEMICONDUCTOR SOLUTIONS CORPORATION, KANAGAWA (JP)

(72) Inventors: Shinya TANIMURA, KANAGAWA (JP); Tatsuji ASHITANI, KANAGAWA (JP)

(21) Appl. No.: 18/870,861

(22) PCT Filed: May 30, 2023
(86) PCT No.: PCT/JP2023/020074

§ 371 Date: Dec. 2, 2024

(30) Foreign Application Priority Data
Jun. 7, 2022 (JP) 2022-092221

(51) Int. Cl. B25J 9/16; B25J 19/02; G06T 7/13; G06T 7/215

(52) U.S. Cl. CPC B25J 9/1697; B25J 19/021; G06T 7/13; G06T 7/215

(57) ABSTRACT

An information processing device according to the present technology includes a movement track estimation section that estimates a movement track of an edge position of a target object in reference to position information associated with an event-caused pixel detected by an event sensor in a previous period before a reference time point in a state where a positional relation between the event sensor and the target object changes such that the target object is displaced within a sensing range of the event sensor, and an edge position estimation section that estimates an edge position of the target object at the reference time point, as a reference time edge position, in reference to the movement track of the edge position estimated by the movement track estimation section.

### TECHNICAL FIELD

The present technology relates to an information processing device, a method for this information processing device, and a program, and particularly to a technology for improving estimation accuracy of an edge position of a target object in a case where the target object is displaced within a sensing range of a sensor.

### BACKGROUND ART

There are various types of technologies associated with image sensing. For example, there is such a technology which estimates an edge position or a shape of a target object by applying an image analysis process to an image captured with use of an image sensor such as an RGB sensor.

For example, such a type of image analysis technology is applied to a field of logistics or the like to determine pickup timing of a target object, such as a cardboard box, by using what is generally called a hand-eye system robot arm, according to a result of image analysis of a captured image of the target object. Specifically, the robot arm in this case is movable in a horizontal direction toward a position where the target object such as a carboard box is disposed. A camera for capturing an image of the lower side is attached to a hand portion provided at a distal end of the robot arm. With movement of the robot arm in the horizontal direction toward the target object, the target object comes into a state recognizable within a camera visual field (sensing range). Thereafter, the timing at which the target object reaches a specific position within the camera visual field is determined as pickup timing of the target object. According to the specific image analysis of this case, a process for estimating an edge position of the target object contained in the captured image is performed. Subsequently, the position of the target object (a position within the captured image) is identified according to the edge position, and timing at which the identified position of the target object reaches a specific position defined in a coordinate system of the image is determined as pickup timing of the target object.

Note that PTL 1 presented below is an associated conventional technology. PTL 1 discloses a technology which detects an edge position of an object from two angles by using a device movable along the object.

### CITATION LIST

### Patent Literature

Japanese Patent Laid-open No. 2021-015616

### SUMMARY

### Technical Problem

Note here that an edge position of a target object is difficult to accurately estimate in a case where image analysis is applied to an image captured under a changing positional relation between the target object and a camera, i.e., in a case where a target object is displaced within a sensing range of a camera (image sensor), such as image analysis in the field of logistics described above.

In the case where the target object is moving within the sensing range, an image of the target object whose edge portion is not accurately recognized may be captured for some reasons such as a change of a state of application of light to the target object during a moving process of the target object. It is difficult to accurately estimate an edge position of the target object from a captured image of such kind. In addition, in a case where such a captured image is designated as a captured image corresponding to pickup timing, accurate determination of pickup timing is difficult to achieve.

The present technology has been developed in consideration of the abovementioned circumstances. An object of the present technology is to improve estimation accuracy of an edge position of a target object in a case where the target object is displaced within a sensing range of a sensor.

### Solution to Problem

An information processing device according to the present technology includes a movement track estimation section that estimates a movement track of an edge position of a target object on the basis of position information associated with an event-caused pixel detected by an event sensor in a previous period before a reference time point in a state where a positional relation between the event sensor and the target object changes such that the target object is displaced within a sensing range of the event sensor, and an edge position estimation section that estimates an edge position of the target object at the reference time point as a reference time edge position in reference to the movement track of the edge position estimated by the movement track estimation section.

The event sensor in the present description corresponds to what is generally called an EVS (Event-based Vision Sensor), and specifically refers to a sensor defined in the following manner. Specifically, the event sensor refers to a sensor which includes multiple pixels each having a light receiving element and which is configured to be capable of detecting a change of a predetermined amount or more of received light as an event, and is capable of outputting information indicating a position of a pixel for which an event has been detected and information indicating a detection time of the event.

According to the configuration described above, even in a case of erroneous detection of an event, the movement track of the edge position of the target object is estimated in reference to the position information associated with the event-caused pixel detected in the previous period before the reference time point. Accordingly, the edge position at the reference time point can be accurately estimated in reference to the estimated movement track. Moreover, the use of the event sensor improves a sampling rate of detection information used for estimation of the edge position movement track of the target object. Accordingly, estimation accuracy of the edge position movement track improves.

Moreover, an information processing method according to the present technology is performed by an information processing device. The information processing device is configured to estimate a movement track of an edge position of a target object on the basis of position information associated with an event-caused pixel detected by an event sensor in a previous period before a reference time point in a state where a positional relation between the event sensor and the target object changes such that the target object is displaced within a sensing range of the event sensor, and estimate an edge position of the target object at the reference time point as a reference time edge position in reference to the estimated movement track of the edge position.

Furthermore, a program according to the present technology is readable by a computer device. The program causes the computer device to achieve a movement track estimation function that estimates a movement track of an edge position of a target object in reference to position information associated with an event-caused pixel detected by an event sensor in a previous period before a reference time point in a state where a positional relation between the event sensor and the target object changes such that the target object is displaced within a sensing range of the event sensor, and an edge position estimation function that estimates an edge position of the target object at the reference time point as a reference time edge position in reference to the movement track of the edge position estimated by the movement track estimation function.

The information processing device according to the present technology described above is implemented by the information processing method and the program presented above.

### BRIEF DESCRIPTION OF DRAWINGS

FIG. 1 is a block diagram illustrating a configuration example of a pickup system according to an embodiment of the present technology.

FIG. 2 depicts diagrams for explaining an outline of a pickup timing arrival determination method according to the embodiment.

FIG. 3 is a diagram for explaining an internal configuration example of an information processing device according to the embodiment.

FIG. 4 is a diagram illustrating an internal configuration example of an event sensor according to the embodiment.

FIG. 5 is a diagram illustrating a configuration example of a pixel included in the event sensor.

FIG. 6 is a diagram for explaining an internal configuration example of an output control and reset circuit according to the embodiment.

FIG. 7 is a functional block diagram illustrating functions included in the information processing device according to the embodiment.

FIG. 8 is a diagram schematically illustrating event data detected by an event sensor in a certain period.

FIG. 9 is a diagram for explaining an edge position movement track estimation method according to the embodiment.

FIG. 10 is a diagram for explaining a specific example of the edge position movement track estimation method according to the embodiment.

FIG. 11 is a flowchart illustrating a specific example of processing procedures for achieving the pickup timing arrival determination method according to the embodiment.

FIG. 12 is an explanatory diagram illustrating a modification associated with displacement of a target object.

### DESCRIPTION OF EMBODIMENT

An embodiment according to the present technology will hereinafter be described in the following order with reference to the accompanying drawings.
<1. Pickup system of embodiment>
<2. Configurations of information processing device and event sensor>
<3. Pickup timing arrival determination method of embodiment>
<4. Processing procedures>
<5. Modifications>
<6. Summary of embodiment>
<7. Present technology>

### 1. Pickup System of Embodiment

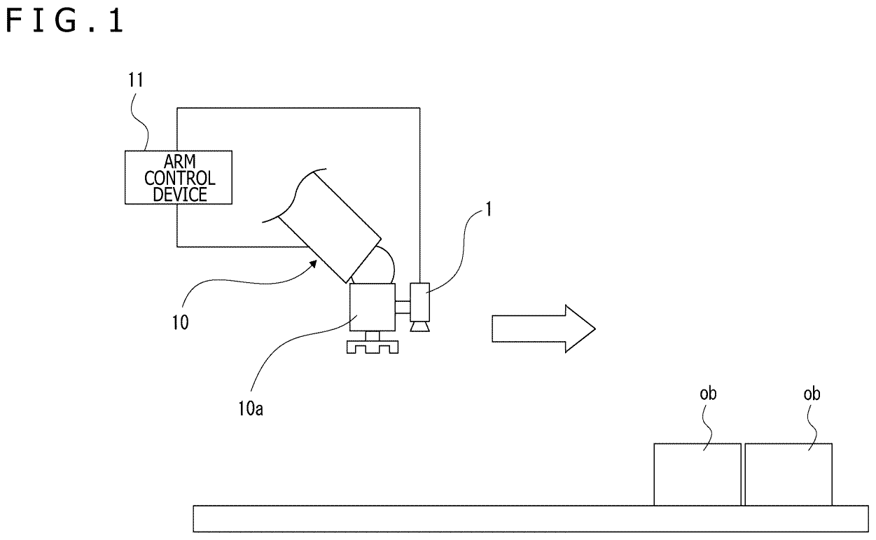

FIG. 1 is a block diagram illustrating a configuration example of a pickup system according to an embodiment of the present technology which includes an information processing device 1 according to the embodiment.

As illustrated in the figure, the pickup system according to the embodiment includes the information processing device 1, a robot arm 10, and an arm control device 11.

The robot arm 10 includes a hand portion 10a that is disposed at an arm distal end and that functions as a suction hand. The robot arm 10 is configured to press the hand portion 10a against a target object ob to suck the target object ob, and pick up the target object ob sucked by the hand portion 10a by driving of the arm.

The arm control device 11 constitutes a control device for controlling movement of the robot arm 10.

The pickup system of the present embodiment is assumed to be applied to a field of logistics, and the target object ob is assumed to be a packing box such as a cardboard box. The packing box has a cubic or rectangular cuboidal external shape, and thus can be expressed as a box having a rectangular shape in a top view. Alternatively, the packing box can be expressed as a box shaped to have edge sides in a top view.

According to the pickup system of the present embodiment, the robot arm is moved to a place where the target object ob corresponding to the packing box is disposed, and sucks and picks up the target object ob by the hand portion 10a. Specifically, the hand portion 10a in the present embodiment faces downward, and the robot arm 10 moves in a horizontal direction in this state. For picking up the target object ob, the hand portion 10a is lowered and pressed against an upper surface of the target object ob to suck the target object ob.

At this time, whether or not the hand portion 10a has reached a position close enough for sucking the target object ob needs to be determined to appropriately pick up the target object ob.

For this determination, a device having a sensing function is attached to the hand portion 10a in the present embodiment as in the cases of conventional hand-eye systems. Specifically, the information processing device 1 is attached to the hand portion 10a.

As described below, the information processing device 1 includes an EVS (Event-based Vision Sensor) 2 functioning as an event sensor to achieve sensing of the target object ob.

Note here that the event sensor in the present description refers to a sensor which includes multiple pixels each having a light receiving element and being configured to be capable of detecting a change of a predetermined amount or more of received light as an event, and which is capable of outputting information indicating a position of a pixel for which an event has been detected and information indicating a detection time of the event.

The EVS 2 of the information processing device 1 has a sensing direction which is the same as the direction in which the hand portion 10a faces, i.e., a downward sensing direction in the present embodiment.

The information processing device 1 includes not only the EVS 2 but also a signal processing unit (control unit 4 described later) and the like performing a process for estimating an edge position of the target object ob recognized within a sensing range of the EVS 2 in reference to detection information obtained by the EVS 2 and a process for determining arrival of pickup timing of the target object ob in reference to the estimated edge position. The configuration of the information processing device 1 will again be described later.

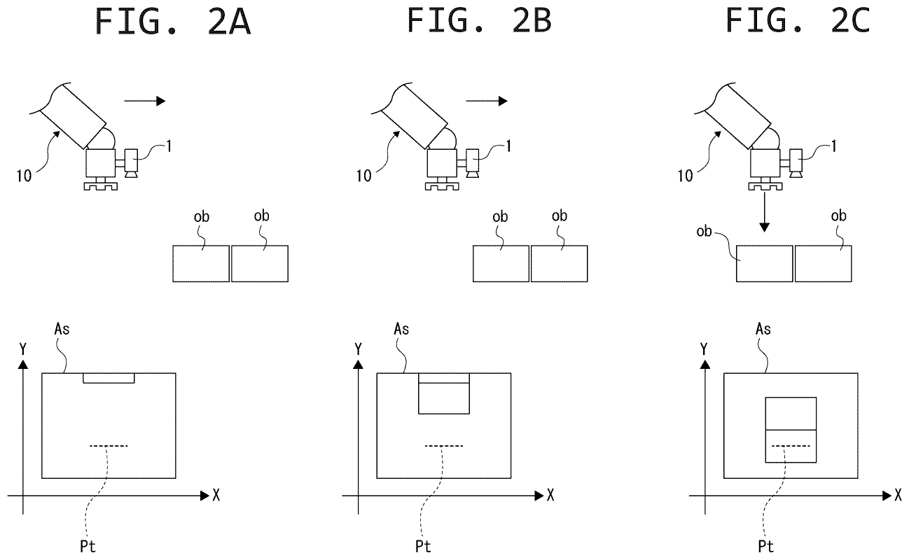

Described with reference to FIG. 2 will be an outline of a pickup timing arrival determination method applied to the target object ob in the present embodiment.

Each of upper parts of FIGS. 2A, 2B, and 2C of FIG. 2 schematically illustrates a state where the robot arm 10 horizontally moves and gradually approaches the target objects ob. It is assumed here that the two target objects ob, i.e., the front target object ob and the rear target object ob as viewed from the robot arm 10, are disposed in a line as the target objects ob.

The terms “front” and “rear” here are defined with reference to the moving direction of the robot arm 10. Specifically, the “front” side refers to the side in the direction opposite to the moving direction of the robot arm 10, while the “rear” side refers to the side in the same direction as the moving direction of the robot arm 10.

In addition, a lower part of each of FIGS. 2A, 2B, and 2C schematically illustrates a state of the target objects ob recognized within a sensing range As of the EVS 2 in correspondence with the state in the upper part.

As obvious with reference to these lower parts, FIG. 2A illustrates a state where only a front edge side portion of the front target object ob is recognized within the sensing range As, FIG. 2B illustrates a state where the whole of the front target object ob and only a front edge side portion of the rear target object ob are recognized within the sensing range As, and FIG. 2C illustrates a state where the whole of the front target object ob and the whole of the rear target object ob are recognized within the sensing range As.

The pickup timing arrival determination according to the present embodiment defines a target position Pt corresponding to pickup timing for the sensing range As of the EVS 2 beforehand. The target position Pt corresponds to a center position of the hand portion 10a projected within the sensing range As. A separation distance between an optical axis of the EVS 2 and the center position of the hand portion 10a is known. Accordingly, the center position of the hand portion 10a within the sensing range As can be calculated according to this separation distance. The center position of the hand portion 10a included in the sensing range As and obtained in such a manner is defined as the target position Pt beforehand.

Note here that the sensing range of the EVS 2 is determined according to an effective pixel range of the EVS 2. Accordingly, the target position Pt is defined as a position in a pixel coordinate system (a coordinate system indicating a pixel position) of the EVS 2.

The pickup timing arrival determination according to the present embodiment determines pickup timing of the target object ob in reference to a positional relation between the target position Pt and a center position of the target object ob recognized within the sensing range As. Specifically, as illustrated in the lower part of FIG. 2C, pickup timing to be determined is such timing at which the center position of the target object ob recognized within the sensing range As reaches a position aligned with the target position Pt.

Note that the center position of the hand portion 10a designated as the reference for the target position Pt is presented only by way of example. For example, in a case where a center position of a suction portion of the hand portion 10a deviates from the center position of the hand portion 10a, the target position Pt may be determined with reference to the center position of the suction portion.

The position to be designated as the reference for determining the target position Pt may be appropriately varied in the hand portion 10a according to actual embodiments, and therefore is not limited to a specific position.

### 2. Configurations of Information Processing Device and Event Sensor

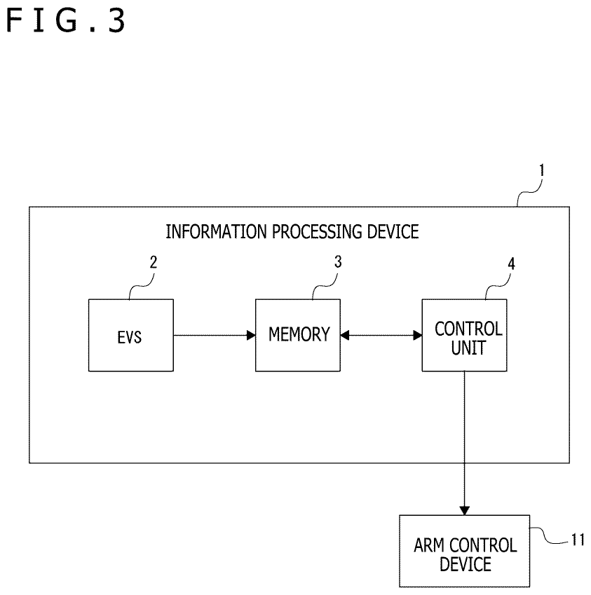

FIG. 3 is a diagram for explaining an internal configuration example of the information processing device 1, and illustrates the arm control device 11 depicted in FIG. 1 in conjunction with the internal configuration example of the information processing device 1.

As illustrated in the figure, the information processing device 1 includes the EVS 2, a memory 3, and the control unit 4.

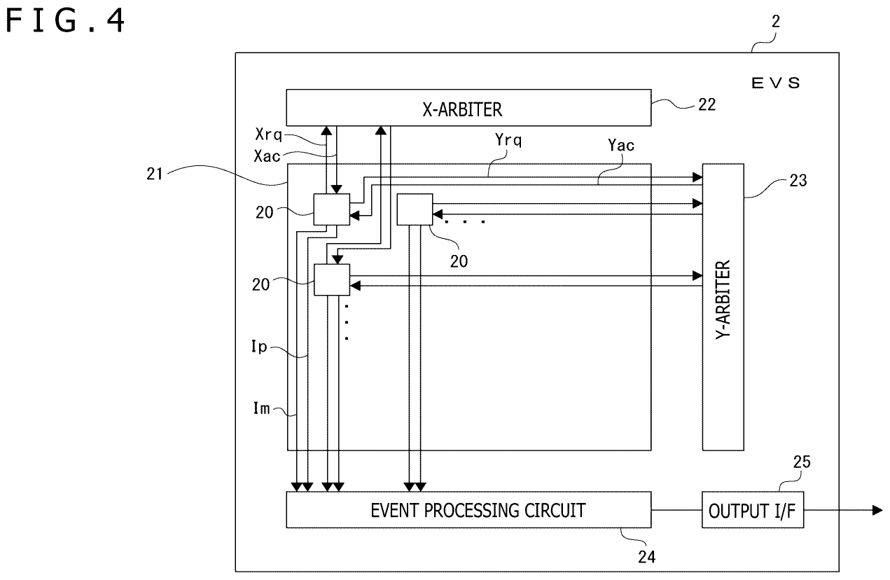

A configuration of the EVS 2 will be described with reference to FIGS. 4 to 6.

FIG. 4 is a diagram illustrating an internal configuration example of the EVS 2.

As illustrated in the figure, the EVS 2 includes a pixel array unit 21 which has multiple pixels 20 two-dimensionally arrayed, an X-arbiter 22, a Y-arbiter 23, an event processing circuit 24, and an output I/F (interface).

In the pixel array unit 21, multiple pixels 20 are arrayed in each of a row direction (a horizontal direction in the figure: an X-direction) and a column direction (a vertical direction in the figure: a Y-direction).

Each of the pixels 20 includes a light receiving element, and is configured to be capable of detecting an event which is a change of a predetermined amount or more of received light. According to the present embodiment, each of the pixels 20 is configured to be capable of detecting an event which is a “positive polarity event” as an increasing change of the predetermined amount or more of the received light and an event which is a “negative polarity event” as a decreasing change of the predetermined amount or more of the received light.

In a case where either a positive polarity event or a negative polarity event is detected, each of the pixels 20 outputs a request signal to the X-arbiter 22 and the Y-arbiter 23 to request readout (output) of an event signal from the corresponding pixel 20. As illustrated in the figure, a request signal for the X-arbiter 22 will be referred to as a “request signal Xrq,” while a request signal for the Y-arbiter 23 will be referred to as a “request signal Yrq.”

Thereafter, each of the pixels 20 outputs an event signal in accordance with arbitrations by the X-arbiter 22 and the Y-arbiter 23 according to the request signals Xrq and Yrq described above. Specifically, each of the pixels 20 outputs to the event processing circuit 24 a positive polarity event signal Ip as a signal indicating a detection result of a positive polarity event, and a negative polarity event signal Im as a signal indicating a detection result of a negative polarity event, in response to reception of a response signal Xac output from the X-arbiter 22 as a response to the request signal Xrq (ACK) and a response signal Yac output from the Y-arbiter 23 as a response to the request signal Yrq.

The X-arbiter 22 and the Y-arbiter 23 arbitrate the request signals received from the respective pixels 20 (the request signals Xrq and Yrq described above), and transmit responses based on the arbitration results (permission or no permission of output of event signals) to the pixels 20 having output the request signals as the response signals (Xac, Yac) described above.

The event processing circuit 24 generates event data associated with the pixels 20 according to the event signals input from the pixels 20 (the positive polarity event signal Ip and the negative polarity event signal Im in the present embodiment).

The data generated as the event data includes at least position information associated with the pixel for which the event has been detected (address information in the pixel coordinate system; hereinafter expressed as “position information associated with the event-caused pixel”), and “detection time information” indicating a detection time of the event. According to the present embodiment, both the positive polarity event and the negative polarity event are detectable as events. Accordingly, for dealing with these events, data to be generated as the event data includes “event type information” as information indicating the type of the detected event (distinction between the positive polarity event and the negative polarity event) as well as the position information associated with the event-caused pixel and the detection time information described above.

An output I/F 25 sequentially outputs event data which has been output from the event processing circuit 24 for each row, to the outside of the EVS 2, specifically, the memory 3 illustrated in FIG. 3 in the present embodiment.

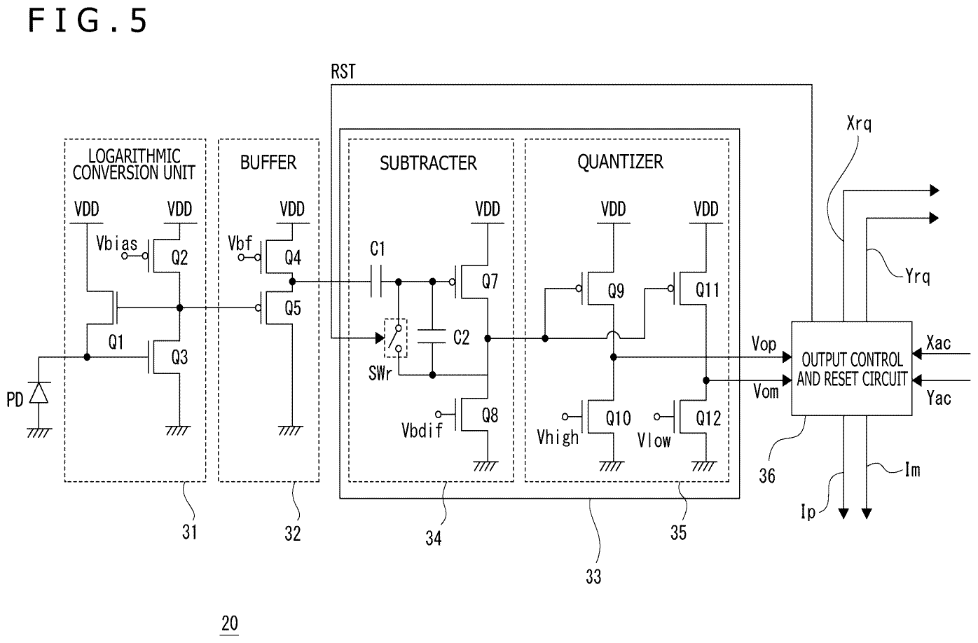

FIG. 5 is a diagram illustrating a circuit configuration example of the pixel 20.

As illustrated in the figure, the pixel 20 includes a photodiode PD functioning as a light receiving element, a logarithmic conversion unit 31, a buffer 32, an event detection circuit 33, and an output control and reset circuit 36.

Electric charge accumulated in the photodiode PD of the pixel 20 is transferred to the logarithmic conversion unit 31. The logarithmic conversion unit 31 converts photocurrent obtained by the photodiode PD (current corresponding to an amount of received light) into a voltage signal indicating a logarithm of this photocurrent.

The buffer 32 corrects the voltage signal input from the logarithmic conversion unit 31, and outputs the corrected voltage signal to the event detection circuit 33.

As illustrated in the figure, the logarithmic conversion unit 31 includes a transistor Q1, a transistor Q2, and a transistor Q3.

Note here that a MOSFET (metal-oxide-semiconductor field-effect transistor) is adopted to constitute each of the respective types of the transistors Q included in the pixel 20 in the present embodiment.

Each of the transistors Q1 and Q3 is an N-type transistor, and the transistor Q2 is a P-type transistor in the logarithmic conversion unit 31.

A source of the transistor Q1 is connected to a cathode of the photodiode PD, while a drain of the transistor Q1 is connected to a power source terminal (reference potential VDD). The transistors Q2 and Q3 are connected in series between the power source terminal and a grounding terminal. Moreover, a connection point between the transistors Q2 and Q3 is connected to a gate of the transistor Q1 and an input terminal (a gate of a transistor Q5 described below) of the buffer 32. Further, a predetermined bias voltage Vbias is applied to a gate of the transistor Q2.

Each drain of the transistors Q1 and Q3 is connected to the power source side (reference potential VDD) to form a source follower circuit. These two source followers connected in a loop shape convert photocurrent received from the photodiode PD into a voltage signal indicating a logarithm of the photocurrent. Meanwhile, the transistor Q2 supplies fixed current to the transistor Q3.

The buffer 32 includes a transistor Q4 and the transistor Q5 each of which is a P-type transistor. The transistors Q4 and Q5 are connected in series between a power source terminal and a grounding terminal.

A connection point between the transistors Q4 and Q5 corresponds to an output terminal of the buffer 32. A corrected voltage signal is output from this output terminal to the event detection circuit 33 as a light reception signal.

The event detection circuit 33 calculates a difference between a level of a current light reception signal and a reference level Lref which is a level of a previous light reception signal to detect a change of an amount of received light as an event. Specifically, the event detection circuit 33 detects presence or absence of an event according to whether or not a level (absolute value) of a difference signal indicating a difference between the reference level Lref and the level of the current light reception signal is a predetermined threshold or higher.

The event detection circuit 33 according to the present embodiment is configured to be capable of separately detecting a positive polarity event, i.e., an event indicating a positive difference from the reference level Lref, and a negative polarity event, i.e., an event indicating a negative difference from the reference level Lref.

The event detection circuit 33 generates a positive polarity output voltage Vop as an output voltage indicating a detection result of a positive polarity event and a negative polarity output voltage Vom as an output voltage indicating a detection result of a negative polarity event.

In this case, the event detection circuit 33 resets the reference level Lref to a level of the current light reception signal according to a reset signal RST described below.

Such reset of the reference level Lref enables detection of a new event according to a change of the light reception signal level from the time of the reset. In other words, the reset of the reference level Lref is equivalent to a return of the event detection circuit 33 to a state where detection of a new event is enabled.

The event detection circuit 33 includes a subtracter 34 and a quantizer 35.

The subtracter 34 lowers the level of the light reception signal (voltage signal) received from the buffer 32, according to the reset signal RST, and outputs the lowered light reception signal to the quantizer 35.

The quantizer 35 quantizes the light reception signal received from the subtracter 34, to obtain an output voltage indicating a quantization result. Specifically, the positive polarity output voltage Vop and the negative polarity output voltage Vom are obtained in the present embodiment.

The subtracter 34 includes capacitors C1 and C2, transistors Q7 and Q8, and a reset switch SWr. The transistor Q7 is a P-type transistor, while the transistor Q8 is an N-type transistor.

The transistors Q7 and 08 are connected in series between a power source terminal and a grounding terminal to constitute an inverter. Specifically, a source and a drain of the transistor Q7 are connected to the power source terminal and a drain of the transistor Q8, respectively, while a source of the transistor Q8 is connected to the grounding terminal. Note that a voltage Vbdif is applied to a gate of the transistor Q8.

One end of the capacitor C1 is connected to the output terminal of the buffer 32, while the other end of the capacitor C1 is connected to a gate of the transistor Q7 (an input terminal of the inverter). One end of the capacitor C2 is connected to the other end of the capacitor C1, while the other end of the capacitor C2 is connected to a connection point between the transistor Q7 and the transistor Q8.

One end of the reset switch SWr is connected to a connection point between the capacitor C1 and the capacitor C2, while the other end of the reset switch SWr is connected to a connection point between the capacitor C2 and the connection point between the transistors Q7 and 08, to be connected in parallel to the capacitor C2. The reset switch SWr is a switch turned on or off according to the reset signal RST.

The inverter constituted by the transistor Q7 and the transistor Q8 inverts the light reception signal input via the capacitor C1, and outputs the inverted light reception signal to the quantizer 35.

It is assumed here that potential generated in the capacitor C1 of the subtracter 34 on the buffer 32 side at a certain point in time is potential Vinit. It is further assumed that the reset switch SWr is turned on at this time. In a case where the reset switch SWr is turned on, the capacitor C1 on the side opposite to the buffer 32 constitutes a virtual grounding terminal. It is assumed that this virtual grounding terminal has potential of zero for convenience of explanation. In this case, charge CHinit accumulated in the capacitor C1 is expressed as the following [Formula 1] on an assumption that the capacitor C1 has capacitance of Cp1.

$$CHinit = Cp 1 \times Vinit \qquad [ Formula 1 ]$$

In addition, a short circuit is caused between both ends of the capacitor C2 when the reset switch SWr is turned on. Accordingly, no charge is accumulated in the capacitor C2.

It is assumed that the reset switch SWr is subsequently turned off. If the amount of the received light changes, the potential of the capacitor C1 on the buffer 32 side changes from the potential Vinit described above. Assuming that this potential after the change is Vafter, charge CHafter accumulated in the capacitor C1 is expressed as the following [Formula 2].

$$CHafter = Cp 1 \times Vafter \qquad [ Formula 2 ]$$

Meanwhile, charge CH2 accumulated in the capacitor C2 is expressed as the following [Formula 3] on an assumption that the capacitor C2 has capacitance of Cp2 and that the subtracter 34 has an output voltage of Vout.

$$CH 2 = - Cp 2 \times Vout \qquad [ Formula 3 ]$$

In this case, a total charge amount of the capacitors C1 and C2 does not change. Accordingly, the following [formula 4] holds.

$$CHinit = CHafter + CH 2 \qquad [ Formula 4 ]$$

[Formula 1] to [Formula 3] are substituted for [Formula 4] to obtain the following [Formula 5].

$$Vout = - ( Cp 1 / Cp 2 ) \times ( Vafter - Vinit ) \qquad [ Formula 5 ]$$

[Formula 5] represents a subtraction action for the voltage signal, and a gain of a subtraction result is Cp1/Cp2.

As apparent from the [Formula 5] presented above, the subtracter 34 outputs a signal indicating a difference between a level of a previous light reception signal (Vinit) and a level of a current light reception signal (Vafter).

Note here that the potential Vinit corresponds to the reference level Lref described above. As can be understood from the above description, the potential Vinit, i.e., the reference level Lref, is reset to the level of the current light reception signal, i.e., the level of the light reception signal at the time when the reset switch SWr is turned on, by turning on the reset switch SWr.

The quantizer 35 includes a transistor Q9, a transistor Q10, a transistor Q11, and a transistor Q12, and constitutes a 1.5-bit quantizer.

Each of the transistors Q9 and Q11 is a P-type transistor, while each of the transistors Q10 and Q12 is an N-type transistor.

As illustrated in the figure, the pair of transistors Q9 and Q10 and the pair of transistors Q11 and Q12 are each connected in series between a power source terminal and a grounding terminal. The output voltage (Vout) of the subtracter 34 is input to each gate of the transistors Q9 and Q11. Moreover, a voltage Vhigh is applied to a gate of the transistor Q10, while a voltage Vlow is applied to a gate of the transistor Q12.

The positive polarity output voltage Vop indicating a detection result of a positive polarity event is obtained at a connection point between the transistor Q9 and the transistor Q10, while the negative polarity output voltage Vom indicating a detection result of a negative polarity event is obtained at a connection point between the transistor Q11 and the transistor Q12.

Specifically, in a case where the output voltage of the subtracter 34 (Vafter-Vinit) has a level of a positive side threshold corresponding to the voltage Vhigh or higher on the transistors Q9 and Q10 side, the positive polarity output voltage Vop corresponding to the H-level is obtained at the connection point between the transistor Q9 and the transistor Q10. Meanwhile, in a case where the output voltage of the subtracter 34 has a level lower than the positive side threshold, the positive polarity output voltage Vop corresponding to the L-level is obtained. Accordingly, a signal indicating whether or not the amount of the received light has changed by a predetermined threshold or more in the increasing direction, i.e., the positive polarity output voltage Vop indicating a detection result of a positive polarity event, is obtained at the connection point between the transistor Q9 and the transistor Q10.

In addition, in a case where the output voltage of the subtracter 34 has a level of a negative side threshold corresponding to the voltage Vlow or lower on the transistors Q11 and Q12 side, the negative polarity output voltage Vom corresponding to the H-level is obtained at the connection point between the transistor Q11 and the transistor Q12. Meanwhile, in a case where the output voltage of the subtracter 34 has a level higher than the negative side threshold, the negative polarity output voltage Vom corresponding to the L-level is obtained. Accordingly, a signal indicating whether or not the amount of the received light has changed by a predetermined threshold or more in the decreasing direction, i.e., the negative polarity output voltage Vom indicating a detection result of a negative polarity event, is obtained at the connection point between the transistor Q11 and the transistor Q12.

The output control and reset circuit 36 outputs the request signals Xrq and Yrq to the X-arbiter 22 and the Y-arbiter 23 described above, outputs the positive polarity event signal Ip and the negative polarity event signal Im corresponding to the response signals Xac and Yac, and outputs the reset signal RST to the reset switch SWr.

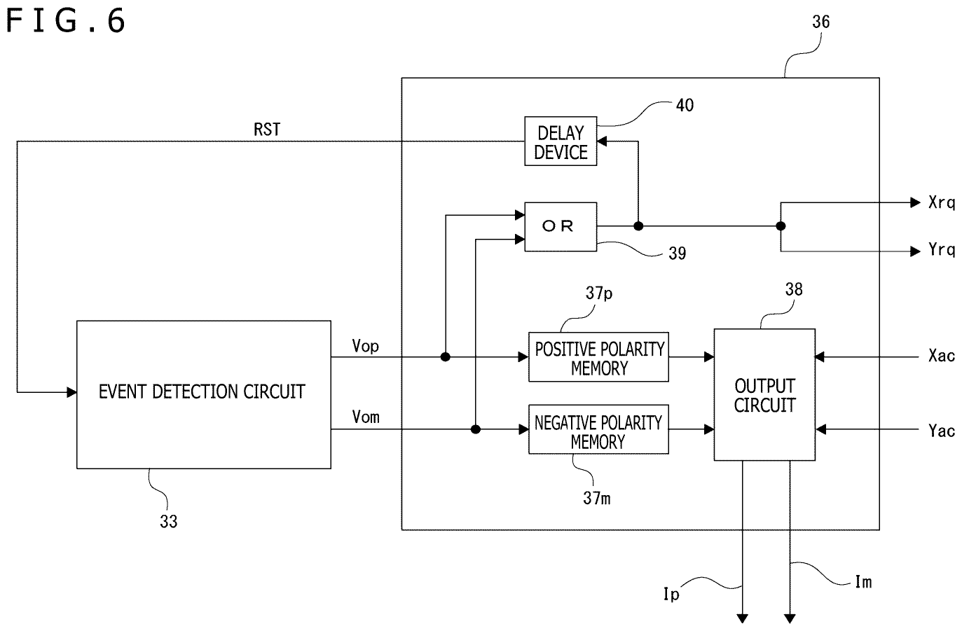

FIG. 6 is a diagram for explaining an internal configuration example of the output control and reset circuit 36, and illustrates the event detection circuit 33 in conjunction with the internal configuration example of the output control and reset circuit 36.

The output control and reset circuit 36 includes a positive polarity memory 37p, a negative polarity memory 37m, an output circuit 38, an OR circuit 39, and a delay device 40.

The positive polarity output voltage Vop received from the event detection circuit 33 is retained at the positive polarity output voltage Vop and input to the OR circuit 39. Meanwhile, the negative polarity output voltage Vom received from the event detection circuit 33 is retained at the negative polarity memory 37m and input to the OR circuit 39.

Note here that the positive polarity memory 37p and the negative polarity memory 37m retain values (digital values) corresponding to voltage levels of the input positive polarity output voltage Vop and the input negative polarity output voltage Vom, respectively. Specifically, according to the present embodiment, “1” is retained for each of the positive polarity output voltage Vop and the negative polarity output voltage Vom input as H-level voltages, while “0” is retained for each of the voltages Vop and Vom input as L-level voltages.

The OR circuit 39 outputs a signal corresponding to the H level in a case where at least either the input positive polarity output voltage Vop or the input negative polarity output voltage Vom has the H level, or outputs a signal corresponding to the L level in a case where both of these voltages Vop and Vom have the L level. In other words, the OR circuit 39 designates the output signal as the H-level signal according to detection of either a positive polarity event or a negative polarity event, and designates the output signal as the L-level signal in a case where no event is detected.

These output signals generated by the OR circuit 39 are transmitted to the X-arbiter 22 and the Y-arbiter 23 as the above-described request signals Xrq and Yrq, respectively.

In response to input of both the response signal Xac from the X-arbiter 22 and the response signal Yac from the Y-arbiter, the output circuit 38 outputs the value retained in the positive polarity memory 37p and the value retained in the negative polarity memory 37m to the event processing circuit 24 as the positive polarity event signal Ip and the negative polarity event signal Im, respectively.

In a case where a positive polarity event is detected, “1” and “0” are output as the positive polarity event signal Ip and the negative polarity event signal Im, respectively. In this manner, the event processing circuit 24 is enabled to identify that the positive polarity event has been detected for the corresponding pixel 20. Meanwhile, in a case where a negative polarity event is detected, “0” and “1” are output as the positive polarity event signal Ip and the negative polarity event signal Im, respectively. In this manner, the event processing circuit 24 is enabled to identify that the negative polarity event has been detected for the corresponding pixel 20.

The delay device 40 delays the output signal generated by the OR circuit 39, and outputs the delayed output signal to the event detection circuit 33 (reset switch SWr) as the reset signal RST. In such a manner, the reference level Lref described above is reset according to detection of either the positive polarity event or the negative polarity event, and the event detection circuit 33 is reset to a state where detection of a new event is enabled.

Note that a delay time of the delay device 40 is only required to be set to at least a time required for retaining the changed positive polarity output voltage Vop or the changed negative polarity output voltage Vom in the positive polarity memory 37p or the negative polarity memory 37m at the time of a change of the level of the positive polarity output voltage Vop or the negative polarity output voltage Vom to the H-level or the L-level. In such a manner, omission of event detection is avoidable.

As described above, the EVS 2 is configured to output data including event data associated with the pixel 20 for which an event of a positive polarity event or a negative polarity event has been detected, i.e., position information associated with the event-caused pixel, detection time information indicating an event detection time, and event type information indicating distinction between the positive polarity event and the negative polarity event.

As illustrated in FIG. 3, event data output from the EVS 2 is stored in the memory 3. Accordingly, event data stored in the memory 3 is available for reference by the control unit 4.

For example, the control unit 4 has a microcomputer which includes a CPU (Central Processing Unit), a ROM (Read Only Memory), a RAM (Random Access Memory), and others. The CPU executes processes in accordance with a program stored in the ROM, or a program loaded to the RAM, for example, to achieve various functions of the information processing device 1.

Particularly, the control unit 4 performs a process for estimating an edge position of the target object ob recognized within the sensing range of the EVS 2 in reference to event data stored in the memory 3, and a process for determining arrival of pickup timing of the target object ob in reference to the estimated edge position. Moreover, the control unit 4 issues an instruction requesting pickup of the target object ob to the arm control device 11 according to determination that pickup timing has arrived. Specifically, the control unit 4 issues to the arm control device 11 an instruction requesting a start of control for causing the robot arm 10 to execute an action for picking up the target object ob.

### 3. Pickup Timing Arrival Determination Method of Embodiment

As described above, in a case where an image sensor such as an RGB sensor is adopted for a hand-eye system robot arm to sense the target object ob, an edge position of the target object ob may be difficult to detect from some captured images due to imaging in a state where the target object is displaced within a sensing range. In this case, pickup timing of the target object ob is difficult to accurately determine.

Accordingly, adopted in the present embodiment is such a method which estimates an edge position of the target object ob in reference to event data detected by the EVS 2 functioning as an event sensor, and determines an arrival of pickup timing in reference to the estimated edge position.

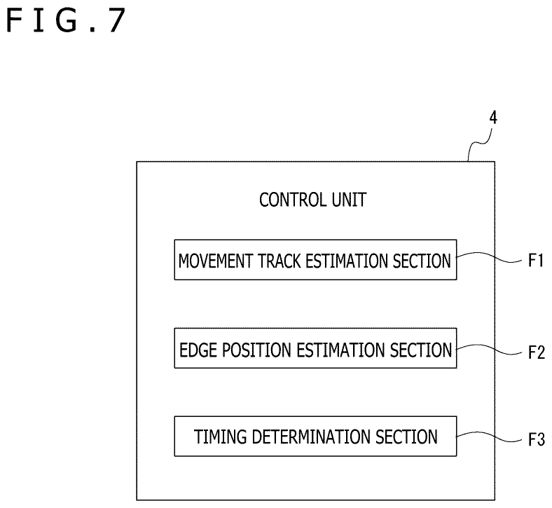

A specific method will hereinafter be described with reference to FIGS. 7 to 10.

FIG. 7 is a functional block diagram illustrating functions achieved by the control unit 4 of the information processing device 1 according to the embodiment.

As illustrated in the figure, the control unit 4 includes a movement track estimation section F1, an edge position estimation section F2, and a timing determination section F3.

The movement track estimation section F1 estimates a movement track of an edge position of the target object ob in reference to position information associated with an event-caused pixel detected by the EVS 2 in a previous period before a reference time point. Specifically, the movement track estimation section F1 estimates the movement track of the edge position of the target object ob in reference to position information associated with the event-caused pixel detected by the EVS 2 in the previous period before the reference time point in a state where a positional relation between the EVS 2 and the target object ob changes such that the target object ob is displaced within the sensing range As of the EVS 2.

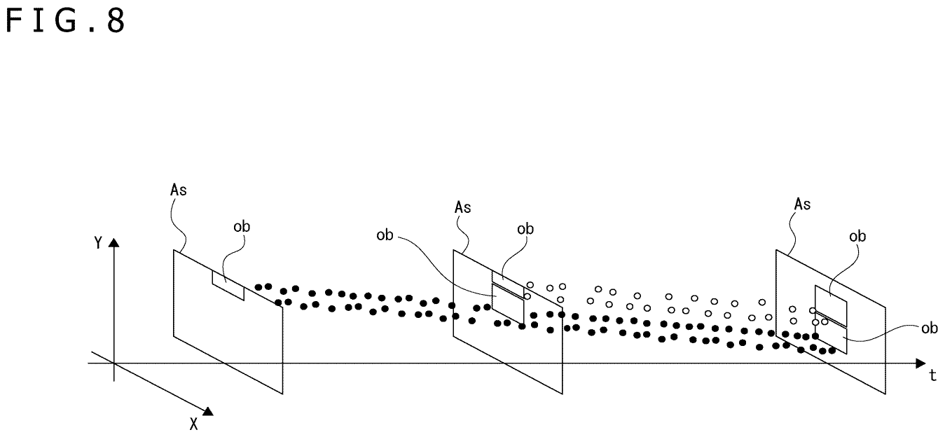

FIG. 8 schematically illustrates event data detected by the EVS 2 in a certain period of time in a state where the positional relation between the EVS 2 and the target object ob changes such that the target object ob is displaced within the sensing range As. Specifically, event data detected by the EVS 2 in the certain period of time in the state where the positional relation between the EVS 2 and the target object ob changes such that the target object ob is displaced within the sensing range As is arranged in a time direction (an axial direction of a time t in the figure) in FIG. 8. Note that only event data detected for the first target object ob is presented here for convenience of illustration.

As illustrated in the figure, the sensing range As here can be expressed as a range in an X-Y plane on an assumption that a row direction and a column direction of the EVS 2 (pixel array unit 21) are X and Y, respectively.

The EVS 2 is configured to detect a change of a predetermined amount or more of received light as an event. Accordingly, the EVS 2 detects an event in response to an edge position of the target object ob. In addition, it is assumed here that the target object ob is displaced within the sensing range As. Accordingly, as illustrated in the figure, a detection position of an event changes in the same direction as a displacement direction of the target object ob with elapse of time.

Specifically, in the figure, each black circle indicates event data of a positive polarity event detected in response to a front edge of the target object ob, while each white circle indicates event data of a negative polarity event detected in response to a rear edge of the target object ob. Each detection position of these events changes in the same direction as the displacement direction of the target object ob with elapse of time.

In the two edges of the target object ob in the displacement direction here, the front edge is considered as an edge recognized earlier in the sensing range As, and the rear edge is considered as an edge recognized in the sensing range As after the front edge. Accordingly, detection of the event of the rear edge (negative polarity event) starts later than that of the event of the front edge (positive polarity event).

As described above, the movement track estimation section F1 estimates a movement track of an edge position of the target object ob in reference to position information associated with an event-caused pixel detected by the EVS 2 in the previous period before the reference time point. Specifically, the movement track estimation section F1 according to the present embodiment estimates a movement track of an edge position of the target object ob in reference to position information associated with an event-caused pixel detected in the previous period at each processing time point in a processing cycle. In other words, the movement track estimation section F1 estimates the movement track in reference to the position information associated with the event-caused pixel detected in the previous period for each processing time point (i.e., each current time) in the processing cycle.

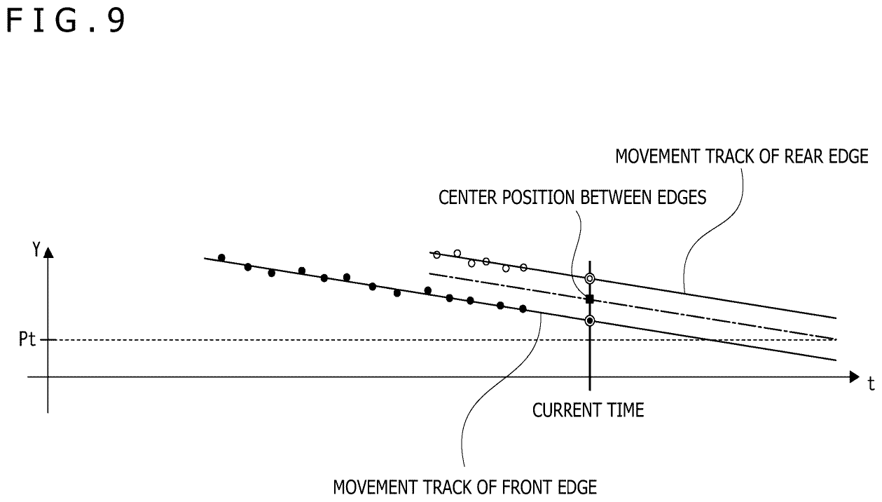

FIG. 9 is a diagram for explaining an edge position movement track estimation method according to the embodiment.

In this figure, event data detected by the EVS 2 in a previous period is plotted in a two-dimensional plane defined by a Y-axis and a t-axis for convenience of explanation.

As illustrated in the figure, each of a movement track of a front edge and a movement track of a rear edge can be estimated by fitting a linear function in reference to multiple pieces of event data detected in the previous period. This fitting may be performed for the multiple pieces of event data detected in the previous period by use of a least squares method.

According to the present embodiment, such estimation of the edge position movement track is carried out at each processing time point in the processing cycle. By such estimation of the edge position movement track at each processing time point, an intersection between each processing time point and a current time on an estimated edge position movement track is obtained. In this manner, each edge position at the corresponding processing time point can be estimated (see double-circle marks in the figure).

The edge position estimation section F2 (FIG. 7) obtains an intersection between each processing time point and the current time on the edge position movement track according to the edge position movement track estimated for each processing time point as described above, and estimates each edge position at the corresponding processing time point. In a different expression, the edge position estimation section F2 estimates a reference time edge as an edge position at a reference time point.

The timing determination section F3 determines arrival of pickup timing of the target object ob in reference to a positional relation between the reference time edge position estimated by the edge position estimation section F2 and a target position Pt defined in the pixel coordinate system of the EVS 2.

Specifically, as illustrated in FIG. 9, the timing determination section F3 in the present embodiment obtains a center position between an estimated edge position of the front edge and an estimated edge position of the rear edge at a current time (current processing time point) (see the black square mark in the figure). Thereafter, the timing determination section F3 determines whether or not this center position has reached the target position Pt to determine arrival of pickup timing.

While FIG. 9 illustrates a state where the center position has not yet reached the target position Pt at the current time by way of example, a determination result that pickup timing has arrived will be obtained in the future at the time when the target position Pt and an extension line of the center position illustrated in the figure cross each other.

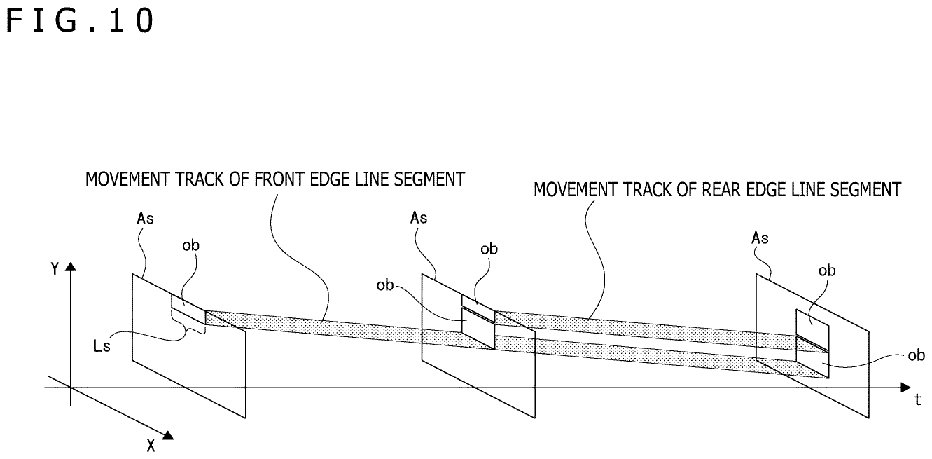

A specific example of the edge position movement track estimation method according to the present embodiment will be described here with reference to FIG. 10.

For estimating an edge position movement track in the present embodiment, a line segment Ls corresponding to an edge side of the target object ob is estimated. Specifically, the movement track estimation section F1 according to the present embodiment estimates the line segment Ls for each processing time point in reference to latest event data stored in the memory 3 (event data newly stored from a previous processing time point). An event occurring in response to an edge side of the target object ob is sequentially detected at a new position in a state where the target object ob is displaced within the sensing range As. In reference to event data concerning the edge side newly detected in such a manner, estimation of the line segment Ls corresponding to this edge side is achieved.

Specifically, in this case, both a front edge side and a rear edge side of the target object ob are estimated as the line segment Ls. The line segment Ls corresponding to the front edge side can be estimated in reference to event data concerning a positive polarity event newly detected. Meanwhile, the line segment Ls corresponding to the rear edge side can be estimated in reference to event data concerning a negative polarity event newly detected.

The line segment Ls corresponding to the front side edge and the line segment Ls corresponding to the rear edge side will hereinafter be referred to as a “front edge line segment” and a “rear edge line segment,” respectively.

The movement track estimation section F1 according to the present embodiment estimates the front edge line segment and the rear edge line segment for each processing time point as described above, and also stores information associated with the front edge line segment and the rear edge line segment thus estimated in the memory 3.

In addition, the movement track estimation section F1 estimates each of a movement track of the front edge line segment and a movement track of the rear edge line segment at each processing time point on the basis of information associated with multiple front edge line segments and multiple rear edge line segments estimated in a previous period.

Note that FIG. 10 illustrates the movement track of the front edge line segment and the movement track of the rear edge line segment of only the first target object ob.

As can be seen from FIG. 10, each of the movement tracks of the edge line segments here is expressed as a band shape, and hence, not only a slope in the Y-t plane (see the slope illustrated in FIG. 9), but also a slope in the X-Y plane needs to be estimated as slopes. Accordingly, the movement track estimation section F1 in this case estimates each of the movement tracks of the edge line segments by fitting not only a linear function indicating the slope in the Y-t plane, but also a linear function indicating the slope in the X-Y plane, in reference to the edge line segments estimated in the previous period.

The edge position estimation section F2 according to the present embodiment estimates a front edge position and a rear edge position of the target object ob in reference to the movement track of the front edge line segment and the movement track of the rear edge line segment estimated by the movement track estimation section F1 in the manner described above. Specifically, the edge position estimation section F2 estimates an intersection line of the movement track of the front edge line segment and the current time and an intersection line of the movement track of the rear edge line segment and the current time as the front edge position and the rear edge position, respectively.

Thereafter, the timing determination section F3 obtains a center position between the edge position of the front edge and the edge position of the rear edge thus estimated, and determines whether or not this center position has reached the target position Pt to determine arrival of pickup timing.

### 4. Processing Procedures

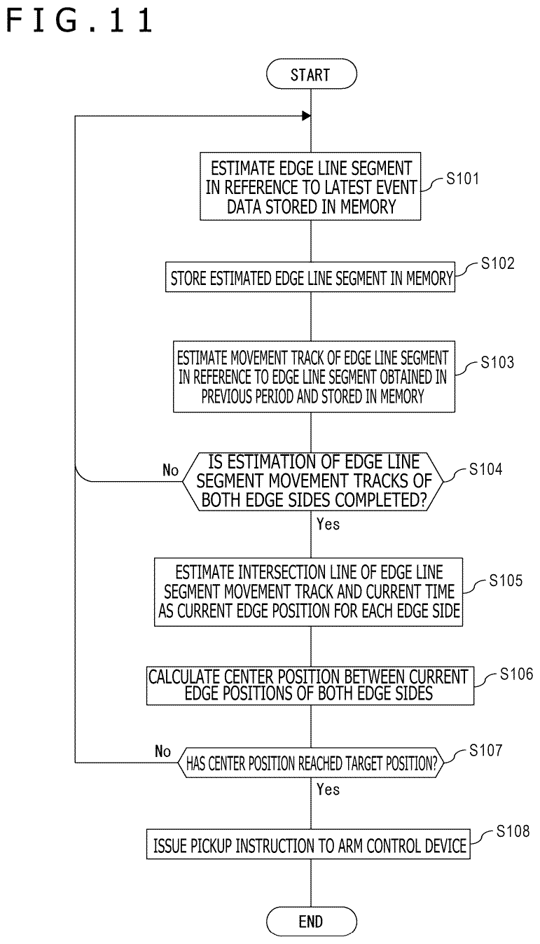

FIG. 11 is a flowchart illustrating a specific example of processing procedures for achieving the pickup timing arrival determination method of the embodiment described above.

The processes illustrated in FIG. 11 are executed by the control unit 4 of the information processing device 1 in accordance with a program stored in the predetermined storage device described above, such as a ROM.

In step S101, the control unit 4 estimates an edge line segment in reference to latest event data stored in the memory 3. Specifically, the control unit 4 estimates a front edge line segment in reference to event data concerning a latest positive polarity event stored in the memory 3, and also estimates a rear edge line segment in reference to event data concerning a latest negative polarity event stored in the memory 3. In this step, no event associated with the target object ob is detected in a state where the corresponding target object ob is not recognized within the sensing range As. Moreover, there may be such a state where only the front edge side in the front and rear edge sides of the target object ob is recognized within the sensing range As. In that case, a positive polarity event associated with the front edge side is detected, but no negative polarity event associated with the rear edge side is detected. In the process of step S101, the control unit 4 estimates the edge line segment of the edge side for which the corresponding event has been detected in the front and rear edge sides.

In step S102 subsequent to step S101, the control unit 4 performs a process for storing the estimated edge line segment in the memory 3.

Thereafter, in step S103 subsequent to step S102, the control unit 4 estimates a movement track of the edge line segment in reference to edge line segments obtained in a previous period and stored in the memory 3. As can be understood from the above description, estimation of the movement track of the edge line segment in this step requires a predetermined multiple number of edge line segments. In the process of step S103, the control unit 4 estimates the movement track of the front edge line segment according to a predetermined multiple number of front edge line segments if the predetermined multiple number or more of front edge line segments are stored in the memory 3. Meanwhile, the control unit 4 estimates the movement track of the rear edge line segment according to a predetermined multiple number of rear edge line segments if the predetermined multiple number or more of rear edge line segments are stored in the memory 3.

In step S104 subsequent to step S103, the control unit 4 determines whether or not the edge line segment movement tracks of both the edge sides have been estimated. Specifically, the control unit 4 determines whether or not movement tracks of both the front edge line segment and the rear edge line segment have been estimated.

In a case where the determination result obtained in step S104 is a negative result that no edge line segment movement track has been estimated for these edge sides, or that only the movement track of the front edge line segment has been estimated, the control unit 4 returns the flow to step S101. In such a manner, the processes from step S101 to S103 are repeated until the edge line segment movement tracks of both the edge sides are estimated.

Meanwhile, in a case where the determination result obtained in step S104 is an affirmative result that the edge line segment movement tracks of both the front edge line segment and the rear edge line segment have been estimated by estimation of the edge line segment movement tracks of both the edge sides, the control unit 4 advances the flow to step S105 to estimate an intersection line of the edge line segment movement track and the current time as a current edge position for each edge side. Specifically, the control unit 4 estimates an intersection line of the movement track of the front edge line segment and the current time as the current edge position of the front edge and an intersection line of the movement track of the rear edge line segment and the current time as the current edge position of the rear edge.

In step S106 subsequent to step S105, the control unit 4 calculates a center position between the current edge positions of both edge sides. Specifically, the control unit 4 calculates a center position between the current edge positions of the front edge and the rear edge estimated in step S105.

In step S107 subsequent to step S106, the control unit 4 determines whether or not the center position has reached the target position Pt. This determination corresponds to pickup timing arrival determination of the target object ob.

In a case where the center position is determined to have not yet reached the target position Pt in step S107, the control unit 4 returns the flow to step S101. In such a manner, estimation of the center position of the target object ob is repeated until arrival at pickup timing.

Meanwhile, in a case where the center position is determined to have reached the target position Pt in step S107, the control unit 4 advances the flow to step S108 to issue a pickup instruction to the arm control device 11. Specifically, the control unit 4 issues to the arm control device 11 an instruction requesting a start of control for causing the robot arm 10 to execute an action for picking up the target object ob.

The control unit 4 ends the series of the processes illustrated in FIG. 11 according to execution of the process in step S108.

While described above has been the example which estimates the edge position movement tracks in reference to only event data, estimation of the edge position movement tracks may be achieved using information indicating a relative speed between the EVS 2 and the target object ob instead of only the event data. Specifically, in a case where the target object ob is picked up by moving only the robot arm 10 as in the present embodiment, information indicating a moving speed of the robot arm 10 is used as information indicating the relative speed.

The use of this information allows estimation of slopes of the edge position movement tracks in consideration of the relative speed between the EVS 2 and the target object ob. Accordingly, estimation accuracy of the movement tracks improves for events erroneously detected.

In a specific example, the information associated with the relative speed is used at the time of fitting of the slopes of the edge position movement tracks by using the least squares method or the like. For example, in a case where a large difference is produced between the slope of the edge position movement track estimated from only event data and the slope of the edge position movement track obtained from the relative speed, a correction may be made such that the slope of the movement track estimated from only the event data approaches the slope of the movement track obtained from the relative speed. Alternatively, for example, the slopes of the movement tracks may be limited such that the slope of the movement track estimated from only the event data does not exceed a predetermined slope range defined with reference to the slope of the movement track obtained from the relative speed.

Moreover, described above has been the example which estimates the rear edge line segment in reference to event data concerning the negative polarity event in accordance with the configuration of the EVS 2 capable of separately detecting positive polarity events and negative polarity events.

Note here that event sensors also include such a type which detects a change of a predetermined amount or more of received light as an event regardless of the polarity of the change of the amount of the received light. Note that this type of event sensor will hereinafter be referred to as a “no-polarity event sensor” for convenience of explanation.

Even in a case where the no-polarity event sensor is used, the following method may be adopted as the method for estimating the rear edge line segment.

Specifically, this is a method which estimates the rear edge line segment in reference to event data (position information associated with an event-caused pixel) detected within a pixel region where a separation distance in a rearward direction from an estimated position of the front edge line segment falls within a predetermined distance range.

In a case where a distance from the front edge side to the rear edge side is identified from a known size of the target object ob in a top view in a state where the front edge line segment has been estimated, it is predicted that the rear edge line segment is recognized within the pixel region where the separation distance in the rearward direction from the estimated position of the front edge line segment falls within the predetermined distance range. Accordingly, as described above, the rear edge line segment is estimated in reference to the position information associated with the event-caused pixel detected within the pixel region where the separation distance in the rearward direction from the estimated position of the front edge line segment falls within the predetermined distance range.

In such a manner, estimation of the rear edge line segment is achievable in reference to event data detected within a pixel region where detection of an event corresponding to the rear edge side is predicted. Accordingly, estimation accuracy of the rear edge line segment improves.

Note that such a method for estimating the rear edge line segment in reference to the separation distance from the estimated position of the front edge line segment is also applicable to a case where an event sensor capable of separately detecting positive polarity events and negative polarity events, such as the EVS 2, is adopted. Specifically, in that case, the rear edge line segment is estimated in reference to event data which is included in event data concerning detected negative polarity events and is detected within a pixel region where a separation distance in a rearward direction from an estimated position of the front edge line segment falls within a predetermined distance range.

### 5. Modifications

Note here that the present technology is not limited to the specific examples described above only by way of example, and may adopt various configurations as modifications.

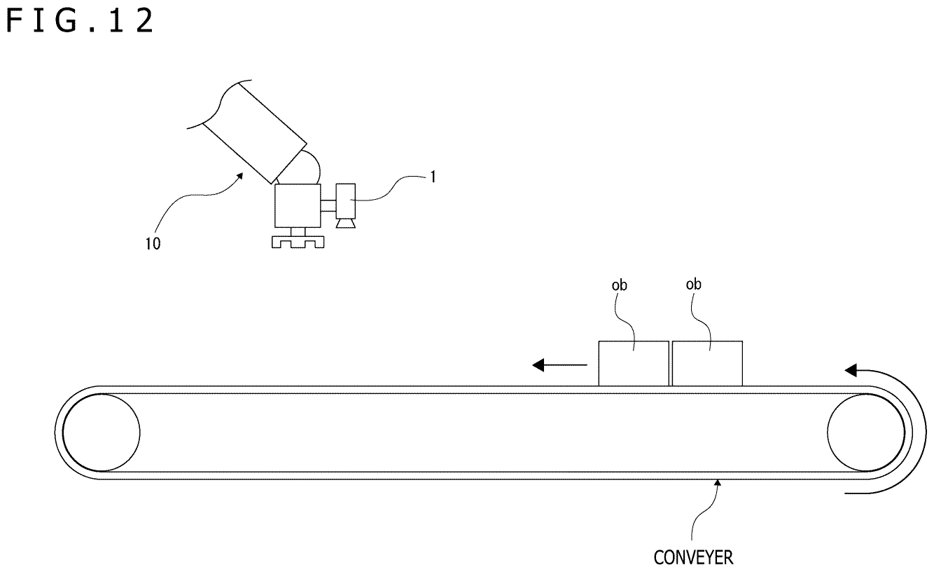

For example, while described above has been the example of the target object ob displaced within the sensing range As in association with movement of the robot arm 10 as an example of a case of the target object ob displaced within the sensing range As, there may be such a case where the target object ob is displaced within the sensing range As in association with conveyance of the target object ob by conveyance means such as a conveyer as illustrated in FIG. 12, for example.

There may also be such a case where the robot arm 10 moves together with conveyance of the target object ob in a predetermined direction by use of a conveyer or the like as described above. Specifically, there may be both a case where the moving direction of the target object ob conveyed by a conveyer or the like is the same as the moving direction of the robot arm 10, i.e., a case where the robot arm 10 follows after and picks up the target object ob conveyed by a conveyer or the like, and a case where the moving direction of the target object ob conveyed by a conveyer or the like is opposite to the moving direction of the robot arm 10.

Accordingly, in these cases, information associated with both the moving direction of the target object ob conveyed by a conveyer or the like and the moving direction of the robot arm 10 may be used for estimating edge position movement tracks. Specifically, estimation of the edge position movement tracks based on the moving speed as described above may be achieved in consideration of the moving direction of the target object conveyed by a conveyer or the like and the moving direction of the robot arm 10.

Note that using the information associated with the moving directions for the estimation of edge position moving tracks may also be applied to a case where the target object ob is not conveyed by a conveyer or the like. For example, in a case where the horizontal moving direction of the robot arm 10 is not fixed, it is effective to use information associated with the moving direction of the robot arm 10 for estimating edge position movement tracks. Specifically, in a case where the robot arm 10 is movable not only in a direction perpendicular to the front edge side or the rear edge side of the target object ob, but also in a diagonal direction with respect to this perpendicular direction, for example, it is effective to use information associated with the moving direction of the robot arm 10 for estimating edge position movement tracks.

Further, while not particularly mentioned above, information indicating a positional error between a center position of the target object ob estimated in reference to event data and the target position Pt may be fed back to movement control of the robot arm 10. For example, in a case where an error is recognized between the center position of the target object ob and the target position Pt, an instruction requesting continuation of movement of the robot arm 10 may be issued to the arm control device 11. Alternatively, the movement amount and the moving direction of the robot arm 10 may be so controlled as to cancel the positional error.

In addition, while described above has been the example which estimates both the front edge position and the rear edge position of the target object ob in reference to event data to estimate the center position of the target object ob, only either the front edge position or the rear edge position is required to be estimated in reference to event data to estimate the center position of the target object ob. If the size of the target object ob in the top view is known, a distance from the front edge position or the rear edge position to the center position is also known. Accordingly, the center position can be estimated from either one of the front edge position and the rear edge position by use of information associated with this distance.

Moreover, while described above has been the example which applies estimation of edge position movement tracks and estimation of edge positions based on the edge position movement tracks according to the present technology to pickup timing arrival determination of the target object ob, application of these estimations of edge position movement tracks and edge positions is not limited to pickup timing arrival determination of the target object ob.

For example, for determination of timing for carrying out labeling, wrapping, printing, or the like for the target object ob, or in a case of use of a conveyer as in the example illustrated in FIG. 12, the estimations of edge position movement tracks and edge positions according to the present technology may also be applied to determination of timing for pushing the target object ob to the outside of the conveyer, for example.

Further, while described above by way of example has been the case where the center position of the target object ob is estimated in reference to the edge position of the target object ob estimated from event data, the position of the target object ob to be estimated in reference to the edge position of the target object ob estimated from event data is not limited to the center position. For example, for a use application such as labeling and printing described above, it is sufficient if a position at which labeling or printing is to be carried out in the target object ob is estimated. Accordingly, the position designated as an estimation target is not limited to the center position.

In addition, while described above has been the example of the target object ob displaced in the horizontal direction, i.e., in the direction parallel to the sensor surface of the EVS 2, as an example of the target object ob displaced within the sensing range As, the “displacement” of the target object ob according to the present technology is not limited to the displacement in the direction parallel to the sensor surface as in such an example, and may also include displacement in a direction perpendicular to the sensor surface (a direction toward and away from the EVS 2).

In a case where the target object ob is displaced in the direction perpendicular to the sensor surface, the target object ob expands and contracts as viewed from the EVS 2. Even in a situation where the target object ob expands or contracts in such a manner, the edge position of the target object ob can be accurately estimated by application of the present technology.

In addition, while described above by way of example has been the device which includes the control unit 4 performing processing for estimating an edge position in reference to event data and the EVS 2 formed integrally with the control unit 4 to constitute the information processing device 1, such a configuration which separately includes the control unit 4 and the EVS 2 (a configuration equipped with devices separately constituting the control unit 4 and the EVS 2) may also be adopted.

### 6. Summary of Embodiment

As described above, the information processing device (information processing device 1) according to the embodiment includes a movement track estimation section (movement track estimation section F1) that estimates a movement track of an edge position of a target object in reference to position information associated with an event-caused pixel detected by an event sensor (EVS 2) in a previous period before a reference time point in a state where a positional relation between the event sensor and the target object changes such that the target object is displaced within a sensing range of the event sensor, and an edge position estimation section (edge position estimation section F2) that estimates an edge position of the target object at the reference time point as a reference time edge position in reference to the movement track of the edge position estimated by the movement track estimation section.

According to the configuration described above, even in a case of erroneous detection of an event, the movement track of the edge position of the target object is estimated in reference to the position information associated with the event-caused pixel detected in the previous period before the reference time point. Accordingly, the edge position at the reference time point can be accurately estimated in reference to the estimated movement track. Moreover, the use of the event sensor improves a sampling rate of detection information used for estimation of the edge position movement track of the target object. Accordingly, estimation accuracy of the edge position movement track improves.

From these two aspects, the present embodiment improves estimation accuracy of the edge position of the target object in the case where the target object is displaced within the sensing range of the sensor.

Moreover, according to the information processing device of the embodiment, the target object has a shape having an edge side in a top view. The movement track estimation section estimates a movement track of a line segment corresponding to the edge side of the target object. The edge position estimation section estimates an edge position corresponding to the edge side, as the reference time edge position, in reference to the movement track of the line segment.

In such a manner, the edge position corresponding to the edge side of the target object can be accurately estimated in the case where the target object has the shape having the edge side in the top view.

Further, according to the information processing device of the embodiment, the target object has a rectangular shape in a top view. The movement track estimation section estimates movement tracks of line segments corresponding to a pair of edge sides that are included in four edge sides of the target object and that face each other in the top view. The edge position estimation section estimates edge side positions as the reference time edge positions for each pair of the edge sides in reference to the movement tracks of the line segments estimated for the pair of edge sides.

In this manner, a center position of the target object can be estimated from the edge positions estimated for the respective facing edge sides of the target object.

For example, for application to a hand-eye system, stable pickup of the target object is achievable by appropriately pressing a suction hand against the center of the target object by the foregoing estimation of the center position of the target object. Accordingly, the target object can be appropriately handled by the estimation of the center position of the target object in such a manner.

In addition, according to the information processing device of the embodiment, assuming that the edge side included in the pair of edge sides and recognized earlier within the sensing range in association with the displacement of the target object is a front edge side and that the edge side facing the front edge side is a rear edge side, the movement track estimation section estimates the line segment corresponding to the rear edge side in reference to position information associated with the event-caused pixel detected in a pixel region where a separation distance in a rearward direction from an estimated position of the line segment corresponding to the front edge side falls within a predetermined distance range.

In a case where a distance from the front edge side to the rear edge side is identified from a known size of the target object in the top view in a state where the line segment of the front edge side has been estimated, it is predicted that the line segment of the rear edge side is recognized within the pixel region where the separation distance in the rearward direction from the estimated line segment position of the front edge side falls within the predetermined distance range. Accordingly, as in the configuration described above, the line segment corresponding to the rear edge side is estimated in reference to the position information associated with the event-caused pixel detected within the pixel region where the separation distance in the rearward direction from the estimated position of the line segment corresponding to the front edge side falls within the predetermined distance range.

In such a manner, estimation of the line segment of the rear edge side is achievable in reference to event information detected within a pixel region where detection of an event corresponding to the rear edge side is predicted. Accordingly, estimation accuracy of the line segment of the rear edge side improves.

Moreover, according to the information processing device of the embodiment, the event sensor is configured to be capable of detecting both a positive polarity event that is an increasing change of a predetermined amount or more of received light and a negative polarity event that is a decreasing change of the predetermined amount or more of the received light. The movement track estimation section estimates the line segment corresponding to the rear edge side in reference to position information associated with an event-caused pixel corresponding to the negative polarity event.

The positive polarity event is detected in a case where the front edge side is recognized within the sensing range of the event sensor. Meanwhile, the negative polarity event is detected in a case where the rear edge side is recognized within the sensing range of the event sensor. Accordingly, appropriate estimation of the line segment of the rear edge side is achievable by estimating the line segment position of the rear edge side in reference to the position information associated with the event-caused pixel corresponding to the negative polarity event in the manner described above.

Further, according to the information processing device of the embodiment, the movement track estimation section uses information indicating a relative speed between the event sensor and the target object to estimate the movement track.

In such a manner, estimation of a slope of the edge position movement track is achievable in consideration of the relative speed between the event sensor and the target object. Accordingly, estimation accuracy of the movement track improves for events erroneously detected.

Estimation accuracy of the reference time edge position improves in association with improvement of the estimation accuracy of the edge position movement track.

In addition, the information processing device of the embodiment further includes a timing determination section (timing determination section F3) that is configured to be capable of inputting detection information obtained by the event sensor attached to a hand portion (hand portion 10a) of a robot arm (robot arm 10) that picks up the target object, and that determines arrival of pickup timing of the target object in reference to a positional relation between the reference time edge position estimated by the edge position estimation section, and a target position (target position Pt) defined in a pixel coordinate system of the event sensor.

In such a manner, determination of the arrival of the timing for picking up the target object by the robot arm is appropriately achievable on the basis of information associated with the edge position of the target object estimated from the event detection information obtained by the event sensor in the previous period.

Moreover, according to the information processing device of the embodiment, the target object has a rectangular shape in a top view. The movement track estimation section estimates movement tracks of line segments corresponding to a pair of edge sides that are included in four edge sides of the target object and that face each other. The edge position estimation section estimates edge side positions as the reference time edge positions for each pair of the edge sides in reference to the movement tracks of the line segments estimated for the pair of edge sides. The timing determination section calculates a center position between the reference time edge positions estimated for each pair of the edge sides, and determines the arrival of the pickup timing in reference to a positional relation between the center position and the target position.

In such a manner, determination of the arrival of the pickup timing is achievable with reference to the center position of the target object in the displacement direction in a situation where the target object is displaced within the sensing range of the event sensor.

Accordingly, stable pickup of the target object is achievable by appropriately pressing the suction hand against the center of the target object.

Furthermore, the information processing device of the embodiment further includes the event sensor.

The information processing device thus configured is a device which includes the event sensor and a signal processing unit for estimating the edge position of the target object in reference to detection information obtained by the event sensor. The event sensor and the signal processing units are unified into one body.

This configuration unifying the devices of the event sensor and the signal processing unit for estimating the edge position into one body eliminates the necessity of providing wiring between the devices of the event sensor and the signal processing unit. Accordingly, attachment to a device to which the information processing device is to be attached, such as a robot arm, improves, as exemplified by reduction of an area occupied for attachment at the time of attachment to this device.

In addition, an information processing method according to the embodiment is performed by an information processing device which is configured to estimate a movement track of an edge position of a target object in reference to position information associated with an event-caused pixel detected by an event sensor in a previous period before a reference time point in a state where a positional relation between the event sensor and the target object changes such that the target object is displaced within a sensing range of the event sensor, and estimate an edge position of the target object at the reference time point, as a reference time edge position, in reference to the estimated movement track of the edge position.

The information processing method of the embodiment described above can also provide operations and effects similar to those of the information processing device of the embodiment described above.

Note here that the embodiment may provide such a program under which the processes described above with reference to FIG. 11 and other figures and performed by the control unit 4 are executed by a CPU, a DSP (Digital Signal Processor), or the like, or by a device including these, for example.

Specifically, a program according to the embodiment is a program readable by a computer device, and causes the computer device to achieve a movement track estimation function that estimates a movement track of an edge position of a target object in reference to position information associated with an event-caused pixel detected by an event sensor in a previous period before a reference time point in a state where a positional relation between the event sensor and the target object changes such that the target object is displaced within a sensing range of the event sensor, and an edge position estimation function that estimates an edge position of the target object at the reference time point, as a reference time edge position, in reference to the movement track of the edge position estimated by the movement track estimation function. Such a program achieves the foregoing functions as the control unit 4 by software processing using the computer device.

The program described above may be recorded beforehand in an HDD (Hard Disk Drive) as a recording medium built in an apparatus such as a computer device, a ROM in a microcomputer including a CPU, or the like.

Alternatively, the program may be temporarily or permanently stored (recorded) in a removable recording medium such as a flexible disk, a CD-ROM (Compact Disc Read Only Memory), an MO (Magneto Optical) disk, a DVD (Digital Versatile Disc), a Blu-ray disc (Blu-ray Disc (registered trademark)), a magnetic disk, a semiconductor memory, and a memory card. Such a removable recording medium may be provided as what is generally called package software.

Alternatively, such a program may be installed from a removable recording medium into a personal computer or the like, or may be downloaded from a download site via a network such as a LAN (Local Area Network) and the Internet.

Moreover, such a program is suited for a purpose of widely providing the information processing device 1 of the embodiment. For example, the program may be downloaded to a personal computer, a portable-type information processing device, a cellular phone, a game console, a video device, a PDA (Personal Digital Assistant), or the like to enable the personal computer or the like to function as a device for achieving the processes as the information processing device 1 according to the present disclosure.

Note that advantageous effects to be offered are not limited to those described in the present description only by way of example. In addition, other advantageous effects may be offered.

### 7. Present Technology

Note that the present technology can also take the following configurations.

(1)

An information processing device including:
a movement track estimation section that estimates a movement track of an edge position of a target object in reference to position information associated with an event-caused pixel detected by an event sensor in a previous period before a reference time point in a state where a positional relation between the event sensor and the target object changes such that the target object is displaced within a sensing range of the event sensor; and
an edge position estimation section that estimates an edge position of the target object at the reference time point as a reference time edge position in reference to the movement track of the edge position estimated by the movement track estimation section.
   (2)

The information processing device according to (1) above, in which
the target object has a shape having an edge side in a top view,
the movement track estimation section estimates a movement track of a line segment corresponding to the edge side of the target object, and
the edge position estimation section estimates an edge position corresponding to the edge side, as the reference time edge position, in reference to the movement track of the line segment.
   (3)

The information processing device according to (2) above, in which
the target object has a rectangular shape in a top view,
the movement track estimation section estimates movement tracks of line segments corresponding to a pair of edge sides that are included in four edge sides of the target object and that face each other in the top view, and
the edge position estimation section estimates edge side positions as the reference time edge positions for each pair of the edge sides in reference to the movement tracks of the line segments estimated for the pair of edge sides.
   (4)

The information processing device according to (3) above, in which, assuming that the edge side included in the pair of edge sides and recognized earlier within the sensing range in association with the displacement of the target object is a front edge side and that the edge side facing the front edge side is a rear edge side, the movement track estimation section estimates the line segment corresponding to the rear edge side in reference to position information associated with the event-caused pixel detected in a pixel region where a separation distance in a rearward direction from an estimated position of the line segment corresponding to the front edge side falls within a predetermined distance range.

(5)

The information processing device according to (3) or (4) above, in which
the event sensor is configured to detect both a positive polarity event that is an increasing change of a predetermined amount or more of received light, and a negative polarity event that is a decreasing change of the predetermined amount or more of the received light, and
the movement track estimation section estimates the line segment corresponding to the rear edge side, in reference to position information associated with an event-caused pixel corresponding to the negative polarity event.
   (6)

The information processing device according to any one of (1) through (5) above, in which the movement track estimation section uses information indicating a relative speed between the event sensor and the target object to estimate the movement track.

(7)

The information processing device according to any one of (1) through (6) above, further including:
a timing determination section that is configured to be capable of inputting detection information obtained by the event sensor attached to a hand portion of a robot arm that picks up the target object, and that determines arrival of pickup timing of the target object in reference to a positional relation between the reference time edge position estimated by the edge position estimation section and a target position defined in a pixel coordinate system of the event sensor.
   (8)

The information processing device according to (7) above, in which
the target object has a rectangular shape in a top view,
the movement track estimation section estimates movement tracks of line segments corresponding to a pair of edge sides that are included in four edge sides of the target object and that face each other,
the edge position estimation section estimates edge side positions as the reference time edge positions for each pair of the edge sides in reference to the movement tracks of the line segments estimated for the pair of edge sides, and
the timing determination section calculates a center position between the reference time edge positions estimated for each pair of the edge sides, and determines the arrival of the pickup timing in reference to a positional relation between the center position and the target position.
   (9)

The information processing device according to any one of (1) through (8) above, further including:
the event sensor.
   (10)

An information processing method performed by an information processing device, the method comprising:
estimating a movement track of an edge position of a target object in reference to position information associated with an event-caused pixel detected by an event sensor in a previous period before a reference time point in a state where a positional relation between the event sensor and the target object changes such that the target object is displaced within a sensing range of the event sensor; and
estimating an edge position of the target object at the reference time point, as a reference time edge position, in reference to the estimated movement track of the edge position.
   (11)

A program readable by a computer device, the program causing the computer device to achieve:
a movement track estimation function that estimates a movement track of an edge position of a target object in reference to position information associated with an event-caused pixel detected by an event sensor in a previous period before a reference time point in a state where a positional relation between the event sensor and the target object changes such that the target object is displaced within a sensing range of the event sensor; and
an edge position estimation function that estimates an edge position of the target object at the reference time point, as a reference time edge position, in reference to the movement track of the edge position estimated by the movement track estimation function.

### REFERENCE SIGNS LIST

1: Information processing device
2: EVS
3: Memory
4: Control unit
10: Robot arm
10a: Hand portion
11: Arm control device
ob: Target object
As: Sensing range
Pt: Target position
20: Pixel
21: Pixel array unit
22: X-arbiter
23: Y-arbiter
24: Event processing circuit
25: Output I/F
Xrq, Yrq: Request signal
Xac, Yac: Response signal
Ip: Positive polarity event signal
Im: Negative polarity event signal
31: Logarithmic conversion unit
32: Buffer
33: Event detection circuit
34: Subtracter
35: Quantizer
36: Output control and reset circuit
PD: Photodiode
Q1 to Q5, Q7 to Q12: Transistor
C1, C2: Capacitor
SWr: Reset switch
Vop: Positive polarity output voltage
Vom: Negative polarity output voltage
37p: Positive polarity memory
37m: Negative polarity memory
38: Output circuit
39: OR circuit
40: Delay device
F1: Movement track estimation section
F2: Edge position estimation section
F3: Timing determination section
Ls: Line segment

What is claimed is:

1. An information processing device comprising:
a movement track estimation section that estimates a movement track of an edge position of a target object in reference to position information associated with an event-caused pixel detected by an event sensor in a previous period before a reference time point in a state where a positional relation between the event sensor and the target object changes such that the target object is displaced within a sensing range of the event sensor; and
an edge position estimation section that estimates an edge position of the target object at the reference time point as a reference time edge position in reference to the movement track of the edge position estimated by the movement track estimation section.

2. The information processing device according to claim 1, wherein
the target object has a shape having an edge side in a top view,
the movement track estimation section estimates a movement track of a line segment corresponding to the edge side of the target object, and
the edge position estimation section estimates an edge position corresponding to the edge side, as the reference time edge position, in reference to the movement track of the line segment.

3. The information processing device according to claim 2, wherein
the target object has a rectangular shape in a top view,
the movement track estimation section estimates movement tracks of line segments corresponding to a pair of edge sides that are included in four edge sides of the target object and that face each other in the top view, and
the edge position estimation section estimates edge side positions as the reference time edge positions for each pair of the edge sides in reference to the movement tracks of the line segments estimated for the pair of edge sides.

4. The information processing device according to claim 3, wherein, assuming that the edge side included in the pair of edge sides and recognized earlier within the sensing range in association with the displacement of the target object is a front edge side and that the edge side facing the front edge side is a rear edge side, the movement track estimation section estimates the line segment corresponding to the rear edge side in reference to position information associated with the event-caused pixel detected in a pixel region where a separation distance in a rearward direction from an estimated position of the line segment corresponding to the front edge side falls within a predetermined distance range.

5. The information processing device according to claim 3, wherein
the event sensor is configured to be capable of detecting both a positive polarity event that is an increasing change of a predetermined amount or more of received light, and a negative polarity event that is a decreasing change of the predetermined amount or more of the received light, and
the movement track estimation section estimates the line segment corresponding to the rear edge side, in reference to position information associated with an event-caused pixel corresponding to the negative polarity event.

6. The information processing device according to claim 1, wherein the movement track estimation section uses information indicating a relative speed between the event sensor and the target object to estimate the movement track.

7. The information processing device according to claim 1, further comprising:
a timing determination section that is configured to be capable of inputting detection information obtained by the event sensor attached to a hand portion of a robot arm that picks up the target object, and that determines arrival of pickup timing of the target object in reference to a positional relation between the reference time edge position estimated by the edge position estimation section and a target position defined in a pixel coordinate system of the event sensor.

8. The information processing device according to claim 7, wherein
the target object has a rectangular shape in a top view,
the movement track estimation section estimates movement tracks of line segments corresponding to a pair of edge sides that are included in four edge sides of the target object and that face each other,
the edge position estimation section estimates edge side positions as the reference time edge positions for each pair of the edge sides in reference to the movement tracks of the line segments estimated for the pair of edge sides, and
the timing determination section calculates a center position between the reference time edge positions estimated for each pair of the edge sides, and determines the arrival of the pickup timing in reference to a positional relation between the center position and the target position.

9. The information processing device according to claim 1, further comprising:
the event sensor.

10. An information processing method performed by an information processing device, the method comprising:
estimating a movement track of an edge position of a target object in reference to position information associated with an event-caused pixel detected by an event sensor in a previous period before a reference time point in a state where a positional relation between the event sensor and the target object changes such that the target object is displaced within a sensing range of the event sensor; and
estimating an edge position of the target object at the reference time point, as a reference time edge position, in reference to the estimated movement track of the edge position.

11. A program readable by a computer device, the program causing the computer device to achieve:
a movement track estimation function that estimates a movement track of an edge position of a target object in reference to position information associated with an event-caused pixel detected by an event sensor in a previous period before a reference time point in a state where a positional relation between the event sensor and the target object changes such that the target object is displaced within a sensing range of the event sensor; and
an edge position estimation function that estimates an edge position of the target object at the reference time point, as a reference time edge position, in reference to the movement track of the edge position estimated by the movement track estimation function.
